(19) United States
(12) Patent Application Publication
(10) Pub. No.: US 2019/0310631 A1
(43) Pub. Date: Oct. 10, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Tadashi Naruse, Wako-shi (JP); Takafumi Hirose, Wako-shi (JP)

(21) Appl. No.: 16/371,198

(22) Filed: Apr. 1, 2019

(30) Foreign Application Priority Data
Apr. 10, 2018 (JP) 2018-075462

(51) Int. Cl. G05D 1/00; G05D 1/02

(52) U.S. Cl. CPC G05D 1/0061; G05D 1/0257; G05D 1/0246; G05D 1/0223

(57) ABSTRACT

A vehicle control device includes a recognizer (130) that recognizes a surrounding situation of a subject vehicle, a driving controller (140, 160) that controls at least one of steering and acceleration/deceleration of the subject vehicle on the basis of a recognition result of the recognizer, a continuation determiner (131, 132) that determines whether or not a specific action by a driver of the subject vehicle other than an action required of the driver continues for a predetermined time or more so that the driving controller operates in a state in which the driving controller is operated, an output (133) that outputs information, and an output controller that causes the output to output request information for requesting a specific operation from the driver in a case in which it is determined by the continuation determiner that the specific action continues for the predetermined time or more. The continuation determiner changes the predetermined time according to a traveling state of the subject vehicle or an ambient environment of the subject vehicle.

### CROSS-REFERENCE TO RELATED APPLICATION

Priority is claimed on Japanese Patent Application No. 2018-075462, filed Apr. 10, 2018, the content of which is incorporated herein by reference.

### BACKGROUND

### Field of the Invention

The present invention relates to a vehicle control device, a vehicle control method, and a storage medium.

### Description of Related Art

In the related art, a technology for determining distraction of a driver is disclosed (for example, Japanese Unexamined Patent Application, First Publication No. 2012-22504).

### SUMMARY

In the related art, attention is focused only on an angular range for determining distraction, and there was a possibility of variation in accuracy when determining distracted driving or a timing of an alarm.

The present invention has been made in consideration of such circumstances, and an object of the present invention is to provide a vehicle control device, a vehicle control method, and a storage medium capable of more suitably determining distracted driving.

A vehicle control device, a vehicle control method, and a storage medium according to the present invention adopt the following constitutions.

(1): A vehicle control device according to an aspect of the present invention includes a recognizer that recognizes a surrounding situation of a subject vehicle, a driving controller that controls at least one of steering and acceleration (or deceleration) of the subject vehicle on the basis of a recognition result of the recognizer, a continuation determiner that determines whether or not a specific action by a driver of the subject vehicle other than an action required of the driver continues for a predetermined time or more so that the driving controller operates in a state in which the driving controller is operated, an output that outputs information, and an output controller that causes the output to output request information for requesting a specific operation from the driver in a case in which it is determined by the continuation determiner that the specific action continues for the predetermined time or more. The continuation determiner changes the predetermined time according to a traveling state of the subject vehicle or an ambient environment of the subject vehicle.

(2): A vehicle control device according to an aspect of the present invention includes a recognizer that recognizes a surrounding situation of a subject vehicle, a driving controller that controls at least one of steering and acceleration/deceleration of the subject vehicle on the basis of a recognition result of the recognizer, a continuation determiner that determines whether or not a specific action by a driver of the subject vehicle other than an action required of the driver continues for a predetermined time or more so that the driving controller operates in a state in which the driving controller is operated, an output that outputs information, and an output controller that causes the output to output request information for requesting a specific operation from the driver in a case in which it is determined by the continuation determiner that the specific action continues for the predetermined time or more. The output controller changes an output aspect of the request information according to a traveling state of the subject vehicle or an ambient environment of the subject vehicle.

(3): In the aspect of (1) or (2) described above, after the output controller causes the output to output the request information at least once or more, in a case in which it is determined by the continuation determiner that the specific action continues for the predetermined time or more, the output controller sets an output aspect of the request information to be stronger than a first output aspect.

(4): In the aspect of (1) to (3) described above, the continuation determiner changes the specific action to be noticed according to a control degree with which the driving controller performs control.

(5): In the aspect of (1) to (4) described above, the traveling state is a state based on a speed of the subject vehicle or a distance to a position at which an operation of the driving controller is changed.

(6): In the aspect of (1) to (5) described above, the ambient environment is at least one of an object sign density around the subject vehicle, a curvature of a route along which the subject vehicle travels, or accuracy of the recognition result by the recognizer.

(7): A vehicle control method according to an aspect of the present invention is a vehicle control method of causing a computer to recognize a surrounding situation of a subject vehicle, control at least one of steering and acceleration/deceleration of the subject vehicle on the basis of a recognition result, determine whether or not a specific action by a driver of the subject vehicle other than an action required of the driver continues for a predetermined time or more so that the control is operated in a state in which the control of the at least one of steering and acceleration/deceleration of the subject vehicle is operated, output request information for requesting a specific operation from the driver in a case in which it is determined that the specific action continues for the predetermined time or more, and change the predetermined time according to a traveling state of the subject vehicle or an ambient environment of the subject vehicle.

(8): A storage medium according to an aspect of the present invention is a storage medium which causes a computer to recognize a surrounding situation of a subject vehicle, control at least one of steering and acceleration/deceleration of the subject vehicle on the basis of a recognition result, determine whether or not a specific action by a driver of the subject vehicle other than an action required of the driver continues for a predetermined time or more so that the control is operated in a state in which the control of the at least one of steering and acceleration/deceleration of the subject vehicle is operated, output request information for requesting a specific operation from the driver in a case in which it is determined that the specific action continues for the predetermined time or more, and change the predetermined time according to a traveling state of the subject vehicle or an ambient environment of the subject vehicle.

According to (1) to (8), it is possible to more suitably determine a distraction operation.

### BRIEF DESCRIPTION OF THE DRAWINGS

FIG. 1 is a constitution diagram of a vehicle control device 1 according to an embodiment.

FIG. 2 is a functional constitution diagram of a first controller 120 and a second controller 160 according to the embodiment.

FIG. 3 is a diagram showing an example of content of vehicle speed threshold value information 181.

FIG. 4 is a diagram showing an example of content of object sign density threshold value information 182.

FIG. 5 is a diagram schematically showing a determination process of a traveling state determiner 131 based on an object sign density.

FIG. 6 is a diagram showing an example of content of distance threshold value information 183.

FIG. 7 is a diagram schematically showing a determination process of the traveling state determiner 131 based on a distance to an automatic driving end position PT.

FIG. 8 is a diagram for explaining a process of a specific action determiner 132.

FIG. 9 is a diagram for explaining a process of the specific action determiner 132 in a case in which an orientation of a face of a driver changes.

FIG. 10 is a diagram showing an example of processes of the traveling state determiner 131 and the specific action determiner 132 based on a speed of a subject vehicle M.

FIG. 11 is a diagram showing an example of the processes of the traveling state determiner 131 and the specific action determiner 132 based on the object sign density.

FIG. 12 is a diagram showing an example of the processes of the traveling state determiner 131 and the specific action determiner 132 based on the distance to the automatic driving end position PT.

FIG. 13 is a diagram for explaining the process of the specific action determiner 132 in a case in which the driver P1 releases hands.

FIG. 14 is a flowchart showing an example of the determination process of the traveling state determiner 131.

FIG. 15 is a flowchart showing an example of a determination process of the specific action determiner 132.

FIG. 16 is a diagram showing an example of content of notification strength information 184.

FIG. 17 is a diagram showing an example of a process of an output controller 133.

FIG. 18 is a diagram showing another example of the process of the output controller 133.

FIG. 19 is a diagram showing an example of a hardware constitution of an automatic driving control device 100 according to the embodiment.

### DESCRIPTION OF EMBODIMENTS

Hereinafter, embodiments of a vehicle control device, a vehicle control method, and a storage medium of the present invention will be described with reference to the drawings.

### Embodiment

[Overall Constitution]

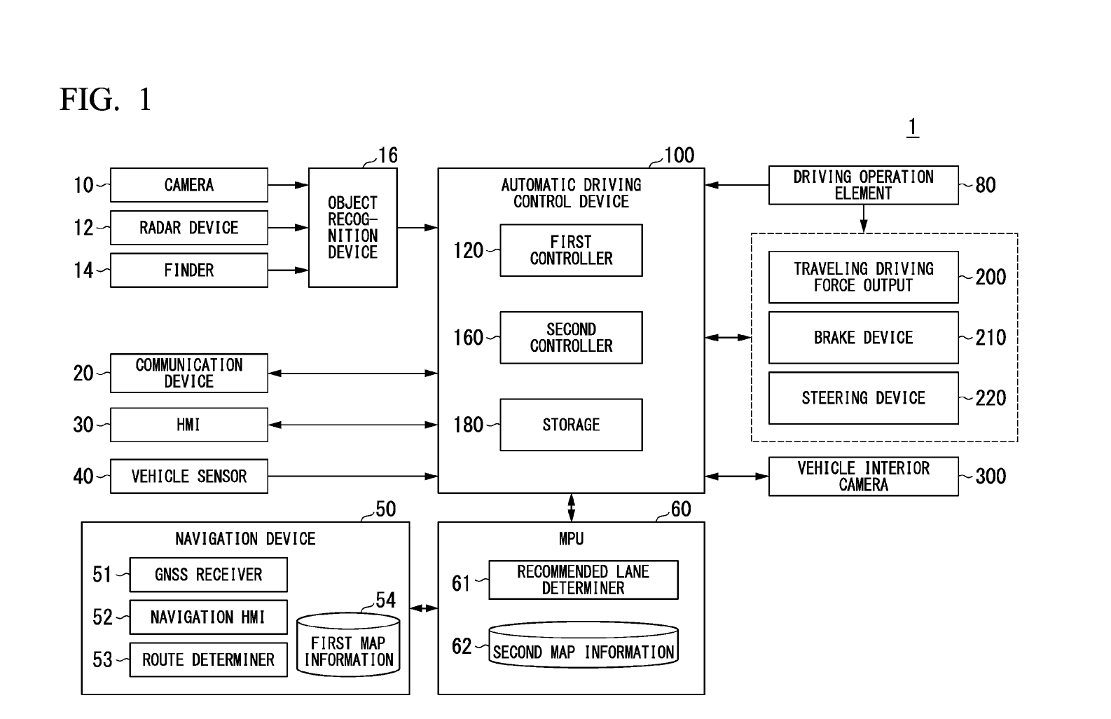

FIG. 1 is a constitution diagram of a vehicle control device 1 according to the embodiment. A vehicle (hereinafter referred to as a subject vehicle M) in which the vehicle control device 1 is mounted is, for example, a vehicle such as a two-wheeled vehicle, a three-wheeled vehicle, or a four-wheeled vehicle, and a driving source of the vehicle includes an internal combustion engine such as a diesel engine or a gasoline engine, an electric motor, or a combination thereof. The electric motor operates using electric power generated by a generator connected to the internal combustion engine or electric power discharged by a secondary battery or a fuel cell. In the present embodiment, as an example, it is assumed that the subject vehicle M is a vehicle to be automatically driven.

For example, the vehicle control device 1 includes a camera 10, a radar device 12, a finder 14, an object recognition device 16, a communication device 20, a human machine interface (HMI) 30, a vehicle sensor 40, a navigation device 50, a map positioning unit (MPU) 60, a driving operation element 80, an automatic driving control device 100, a traveling driving force output 200, a brake device 210, a steering device 220, and a vehicle interior camera 300. Such devices and instruments are connected to each other by a multiple communication line such as a controller area network (CAN) communication line, a serial communication line, a wireless communication network, or the like. The constitution shown in FIG. 1 is merely an example, and part of the constitution may be omitted or another constitution may be further added.

For example, the camera 10 is a digital camera using a solid imaging element such as a charge coupled device (CCD) or a complementary metal oxide semiconductor (CMOS). The camera 10 is attached to an arbitrary place on the subject vehicle M. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. The radar device 12 is attached to an arbitrary place on the subject vehicle M. The radar device 12 may detect the position and the speed of the object by a frequency modulated continuous wave (FM-CW) method.

The finder 14 is a light detection and ranging (LIDAR). The finder 14 irradiates light around the subject vehicle M and measures scattered light. The finder 14 detects the distance to the object on the basis of a time from light emission to light reception. For example, the irradiated light is laser light of a pulse shape. The finder 14 is attached to an arbitrary place on the subject vehicle M.

The object recognition device 16 performs a sensor fusion process on a detection result by a part or all of the camera 10, the radar device 12, and the finder 14 to recognize a position, a type, a speed, and the like of the object. The object recognition device 16 outputs a recognition result to the automatic driving control device 100. The object recognition device 16 may output the detection result of the camera 10, the radar device 12, and the finder 14 as they are to the automatic driving control device 100. The object recognition device 16 may be omitted from the vehicle control device 1.

For example, the communication device 20 communicates with another vehicle that is present around the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like.

For example, the navigation device 50 includes a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40.

The navigation HMI 52 includes a display device, a speaker, a touch panel, a key, and the like. Part or all of the navigation HMI 52 may be shared with the HMI 30 described above.

For example, the route determiner 53 determines a route (hereinafter referred to as a route on a map) from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route on the map is output to the MPU 60.

The navigation device 50 may perform route guidance using the navigation HMI 52 on the basis of the route on the map. For example, the navigation device 50 may be realized by a function of a terminal device such as a smartphone or a tablet terminal possessed by the occupant. The navigation device 50 may transmit a current position and a destination to a navigation server through the communication device 20 and acquire the same route as the route on the map from the navigation server.

For example, the MPU 60 includes a recommended lane determiner 61 and holds second map information 62 in the storage device such as an HDD or a flash memory. The recommended lane determiner 61 divides the route on the map provided from the navigation device 50 into a plurality of blocks (for example, divides the route into intervals of 100 [m] in a vehicle progress direction), and determines a recommended lane for each block by referring to the second map information 62. The recommended lane determiner 61 determines the number of a lane from the left that the vehicle travels in. In a case in which a branching position is present in the route on the map, the recommended lane determiner 61 determines the recommended lane so that the subject vehicle M is able to travel on a reasonable travel route for progressing to a branch destination.

The second map information 62 is map information with accuracy higher than that of the first map information 54. For example, the second map information 62 may include information on the center of a lane, information on a boundary of a lane, information on a type of the lane, or the like. The second map information 62 may include road information, traffic regulation information, address information (an address and a postal code), facility information, telephone number information, and the like. The second map information 62 may be updated at any time by the communication device 20 communicating with another device.

The driving operation element 80 includes, for example, an acceleration pedal, a brake pedal, a shift lever, a steering wheel, a modified steering wheel, a joystick, and other operation elements. A sensor that detects an operation amount or presence or absence of an operation is attached to the driving operation element 80, and a detection result of the sensor is output to the automatic driving control device 100, or part or all of the traveling driving force output 200, the brake device 210, and the steering device 220.

For example, the automatic driving control device 100 includes a first controller 120, a second controller 160, and a storage 180. For example, each of first controller 120 and the second controller 160 is realized by a processor such as a central processing unit (CPU) executing a program (software). Some or all of such constitution elements may be realized by hardware (a circuit unit including a circuitry) such as a large scale integration (LSI), an application specific integrated circuit (ASIC), a field-programmable gate array (FPGA), or a graphics processing unit (GPU), or may be realized by software and hardware in cooperation. The program may be stored in the storage 180 of the automatic driving control device 100 in advance. Alternatively, the program may be stored in a detachable storage medium such as a DVD or a CD-ROM and may be installed in the storage 180 by the attachment of the storage medium to a drive device.

The storage 180 is realized by, for example, an HDD, a flash memory, an electrically erasable programmable read only memory (EEPROM), a read only memory (ROM), or a random access memory (RAM). The storage 180 stores, for example, a program that is read and executed by the processor. The storage 180 stores vehicle speed threshold value information 181, object sign density threshold value information 182, and distance threshold value information 183. Details of each of pieces of information will be described later.

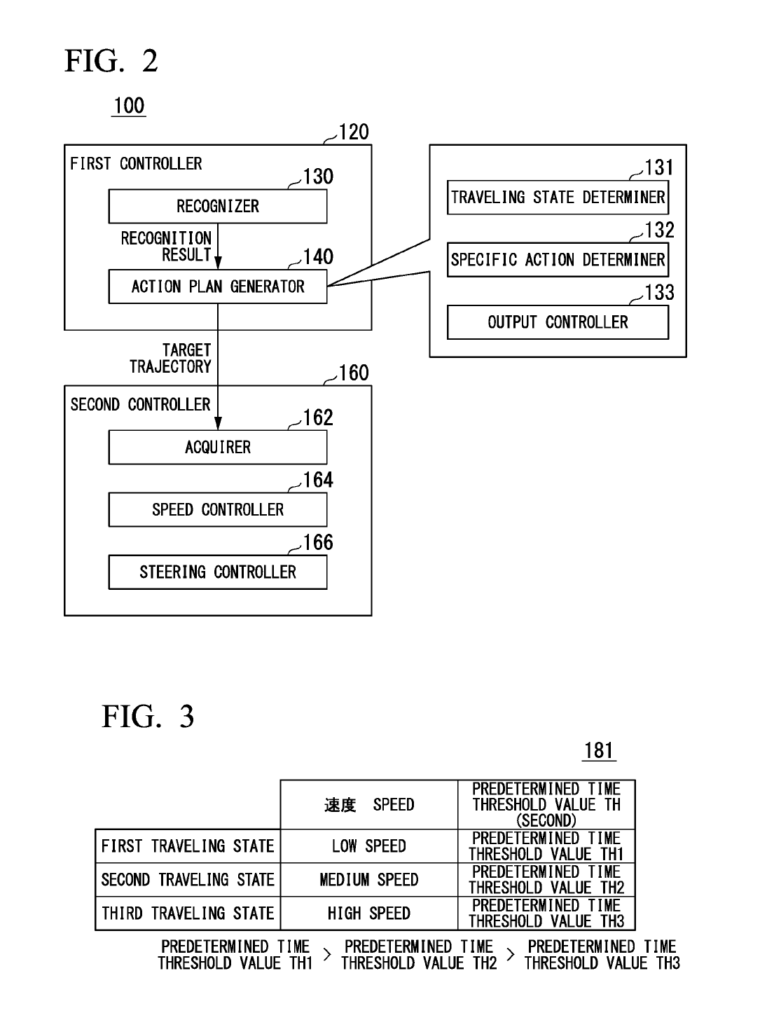

FIG. 2 is a functional constitution diagram of the first controller 120 and the second controller 160 according to the embodiment. For example, the first controller 120 includes a recognizer 130 and an action plan generator 140. The recognizer 130 includes a traveling state determiner 131, a specific action determiner 132, and an output controller 133. For example, the first controller 120 realizes a function of artificial intelligence (AI) and a function of a previously given model in parallel. For example, a function of “recognizing an intersection” may be realized by executing recognition of an intersection by deep learning or the like and recognition based on a previously given condition (there is a pattern matching signal, a road sign, or the like) in parallel, giving scores to both sides, and comprehensively evaluating the scores. Therefore, reliability of automatic driving is guaranteed.

The recognizer 130 recognizes a surrounding situation of the subject vehicle M, on the basis of information input from the camera 10, the radar device 12, and the finder 14 through the object recognition device 16. Specifically, the recognizer 130 recognizes a situation such as the position, speed, and acceleration of the object in the vicinity of the subject vehicle M. The position of the object is recognized as a position in absolute coordinates using a representative point (a center of gravity, a drive shaft center, or the like) of the subject vehicle M as an origin and is used in control. The position of the object may be represented by the representative point such as the center of gravity or a corner of the object, or may be represented by an expressed region. A “state” of the object may include an acceleration or a jerk of the object, or an “action state” (for example, whether or not the object is changing a lane or trying to change a lane).

For example, the recognizer 130 recognizes a lane (traveling lane) on which the subject vehicle M is traveling. For example, the recognizer 130 recognizes the traveling lane by comparing a pattern of a road lane marking (for example, an arrangement of a solid line and a broken line) obtained from the second map information 62 with a pattern of a road lane marking around the subject vehicle M recognized from the image captured by the camera 10. The recognizer 130 may recognize the traveling lane by recognizing a traveling road boundary (a road boundary) including a road lane marking, a road shoulder, a curb stone, a median strip, a guard rail, and the like, and is not limited to recognizing road lane markings. In this recognition, the position of the subject vehicle M acquired from the navigation device 50 or a process result by an INS may be added. The recognizer 130 recognizes a temporary stop line, an obstacle, a red light, a toll gate, and other road events.

When recognizing the traveling lane, the recognizer 130 recognizes the position and a posture of the subject vehicle M with respect to the traveling lane. For example, the recognizer 130 may recognize a deviation of a reference point of the subject vehicle M from a center of the lane and an angle formed by a line connecting the center of the lane of a progress direction of the subject vehicle M as a relative position and the posture of the subject vehicle M with respect to the traveling lane. Instead of this, the recognizer 130 may recognize a position of the reference point of the subject vehicle M with respect to one of the side portions (the road lane markings or the road boundaries) of the traveling lane as the relative position of the subject vehicle M with respect to the traveling lane.

In the recognition process described above, the recognizer 130 may derive recognition accuracy and output the recognition accuracy as recognition accuracy information to the action plan generator 140. For example, the recognizer 130 generates the recognition accuracy information on the basis of a frequency of recognition of the road lane markings in a certain period. Functions of the traveling state determiner 131, the specific action determiner 132, and the output controller 133 included in the recognizer 130 will be described later.

The action plan generator 140 generates a target trajectory in which the subject vehicle M travels in the future so that the subject vehicle M travels on the recommended lane determined by the recommended lane determiner 61 in principle and further automatic driving coping with the surrounding situation of the subject vehicle M is executed. The target trajectory includes, for example, a speed element. For example, the target trajectory is expressed as a sequence of points (trajectory points) where the subject vehicle M should reach. The trajectory point is a point where the subject vehicle M should reach each predetermined traveling distance (for example, about several [m]) along a road, and separately from that, a target speed and a target acceleration for each predetermined sampling time (for example, about 0 comma several [sec]) are generated as part of the target trajectory.

For example, the second controller 160 includes an acquirer 162, a speed controller 164, and a steering controller 166. The acquirer 162 acquires information on the target trajectory generated by the action plan generator 140 and stores the information in a memory (not shown). The speed controller 164 controls the traveling driving force output 200 or the brake device 210 on the basis of a speed element accompanying the target trajectory stored in the memory. The steering controller 166 controls the steering device 220 according to a degree of curvature of the target trajectory stored in the memory. For example, a process of the speed controller 164 and the steering controller 166 is realized by a combination of a feed-forward control and a feedback control. As an example, the steering controller 166 is executed by a combination of a feed-forward control according to a curvature of the road ahead of the subject vehicle M and a feedback control based on the deviation from the target trajectory. A combination of the action plan generator 140 and the second controller 160 is an example of a “driving controller”.

Returning to FIG. 1, the traveling driving force output 200 outputs, to driving wheels, traveling driving force (torque) for enabling the vehicle to travel. For example, the traveling driving force output 200 includes a combination of an internal combustion engine, an electric motor, a transmission, and the like, and an ECU that controls the internal combustion engine, the electric motor, the transmission, and the like. The ECU controls the above-described constitutions according to the information input from the second controller 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the second controller 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the second controller 160 to transfer the oil pressure of the master cylinder to the cylinder.

For example, the steering device 220 includes a steering ECU and an electric motor.

For example, the electric motor changes a direction of steerable wheels by applying a force to a rack and pinion mechanism. The steering ECU changes the direction of the steerable wheels by driving the electric motor according to the information input from the second controller 160 or the information input from the driving operation element 80.

For example, the vehicle interior camera 300 captures an image including a face of the occupant sitting on a seat installed in a vehicle interior of the subject vehicle M. The occupant is, for example, an occupant seated on a driver's seat (hereinafter referred to as a driver), but may also be an occupant (passenger) seated on a passenger seat or a rear seat in addition to the driver. The vehicle interior camera 300 is, for example, a digital camera using a solid-state imaging device such as a charge coupled device (CCD) or a complementary metal oxide semiconductor (CMOS). For example, the vehicle interior camera 300 captures an image of the occupant at a predetermined timing. The captured image of the vehicle interior camera 300 is output to the automatic driving control device 100 (the first controller 120).

[Regarding Traveling State Determiner 131 and Specific Action Determiner 132]

Hereinafter, each functional unit included in the recognizer 130 will be described. The traveling state determiner 131 determines a traveling state of the subject vehicle M or an ambient environment of the subject vehicle M and determines a threshold value used for a determination by the specific action determiner 132 on the basis of the determined traveling state or the ambient environment. The traveling state includes, for example, the speed of the subject vehicle M or a distance to a position at which the automatic driving of the subject vehicle M is ended (hereinafter referred to as an automatic driving end position PT). The ambient environment includes the density of an object sign (for example, another vehicle) that is present around the subject vehicle M. The traveling state determiner 131 determines (decides) a threshold value (hereinafter referred to as a predetermined time threshold value TH) used when the specific action determiner 132 determines whether or not a specific action by the driver of the subject vehicle M continues for a predetermined time or more. In a case in which an operation aspect of the automatic driving control by the automatic driving control device 100 is the lane keeping control in a state in which the steering wheel is released, an action required of the driver is an action looking at the progress direction. In a case in which the operation aspect of the automatic driving control by the automatic driving control device 100 is the lane keeping control in a state in which the steering wheel is released, the specific action is, for example, an action of looking away from the progress direction (hereinafter, “distraction”). A combination of the traveling state determiner 131 and the specific action determiner 132 is an example of a “continuation determiner”.

[Regarding Vehicle Speed Threshold Value Information 181]

FIG. 3 is a diagram showing an example of content of the vehicle speed threshold value information 181. The vehicle speed threshold value information 181 is information in which the speed of the subject vehicle M and the predetermined time threshold value TH are associated with each other. Specifically, a “predetermined time threshold value TH1” is associated with a “low speed,” a “predetermined time threshold value TH2” is associated with a “medium speed,” and a “predetermined time threshold value TH3” is associated with a “high speed”. In the following description, a state in which the speed of the subject vehicle M is the “low speed” is also described as a “first traveling state,” a state in which the speed of the subject vehicle M is the “medium speed” is also described as a “second traveling state,” and a state in which the speed of the subject vehicle M is the “high speed” is also described as a “third traveling state”. A relationship among a length of time indicated by the predetermined time threshold value TH1, a length of time indicated by the predetermined time threshold value TH2, and a length of time indicated by the predetermined time threshold value TH3 is the predetermined time threshold value TH1>the predetermined time threshold value TH2>the predetermined time threshold value TH3.

In a case in which the speed of the subject vehicle M detected by the vehicle sensor 40 is the “low speed,” the vehicle speed threshold value information 181 determines the threshold value used for the determination by the specific action determiner 132 as the “predetermined time threshold value TH1,” in a case in which the speed of the subject vehicle M detected by the vehicle sensor 40 is “medium speed,” the vehicle speed threshold value information 181 determines the threshold value used for the determination by the specific action determiner 132 as the “predetermined time threshold value TH2,” and in a case in which the speed of the subject vehicle M detected by the vehicle sensor 40 is “high speed,” the vehicle speed threshold value information 181 determines the threshold value used for the determination by the specific action determiner 132 as the “predetermined time threshold value TH3”.

[Regarding Object Sign Density Threshold Value Information 182]

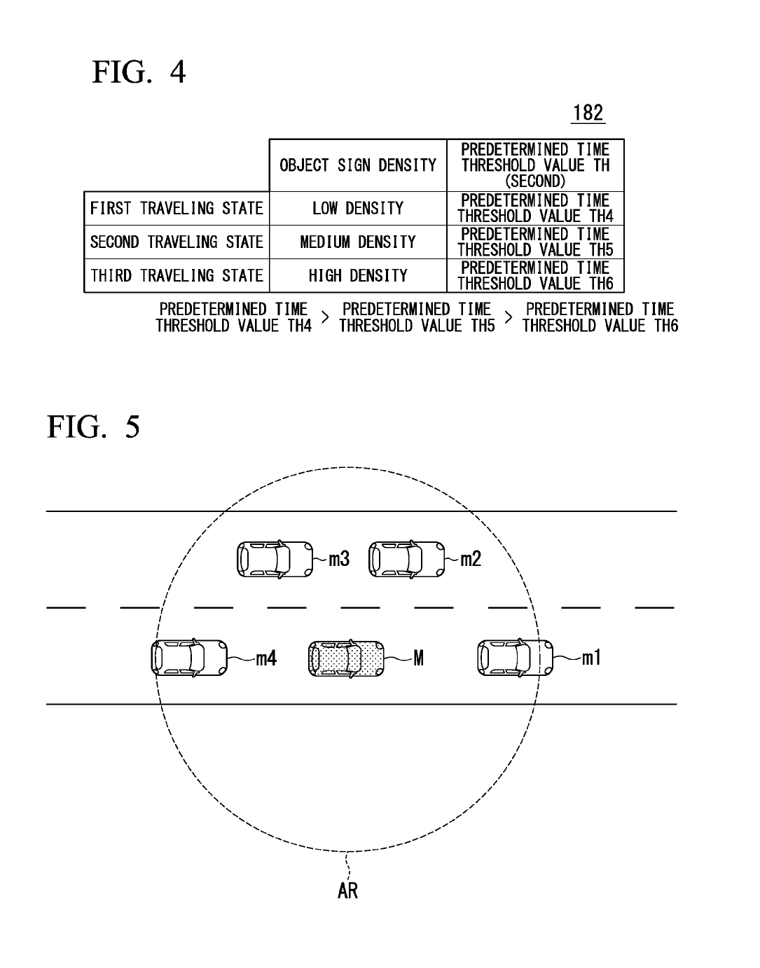

FIG. 4 is a diagram showing an example of content of the object sign density threshold value information 182. The object sign density threshold value information 182 is information in which a density of an object sign near the subject vehicle M and the predetermined time threshold value TH are associated with each other. Specifically, a “predetermined time threshold value TH4” is associated with a “low density,” a “predetermined time threshold value TH5” is associated with a “medium density,” and a “predetermined time threshold value TH6” is associated with a “high density”. In the following description, a state in which the subject vehicle M is in the “low density” is also described as a “first traveling state,” a state in which the vehicle M is in the “medium density” is also described as a “second traveling state,” and a state in which the subject vehicle M is in the “high density” is also described as a “third traveling state”. A relationship among a length of time indicated by the predetermined time threshold value TH4, a length of time indicated by the predetermined time threshold value TH5, and a length of time indicated by the predetermined time threshold value TH6 is the predetermined time threshold value TH4>the predetermined time threshold value TH5>the predetermined time threshold value TH6. In the following description, the density of the object sign near the subject vehicle M is described as an “object sign density”.

FIG. 5 is a diagram schematically showing a determination process of the traveling state determiner 131 based on the object sign density. For example, the traveling state determiner 131 acquires an object sign density on the basis of a recognition result in which object signs (the other vehicles m1 to m4 shown in the figure) are present in a predetermined range (a predetermined range AR shown in the figure) that is able to be recognized by the recognizer 130 is recognized and determines the predetermined time threshold value TH on the basis of the acquired object sign density.

In the above description, a case in which the object sign that is present in the predetermined range AR is the other vehicle m has been described as an example, but the present invention is not limited thereto, and the object sign may be another object. Instead of a constitution in which the traveling state determiner 131 recognizes the object sign that is present in the predetermined range by the recognizer 130, the traveling state determiner 131 may have a constitution in which the traveling state determiner 131 acquires the object sign density by recognizing the object sign (the other vehicle m) near the subject vehicle M by inter-vehicle communication with the other vehicle m in the predetermined range AR a predetermined distance from the subject vehicle M. Instead of the object sign density, the specific action determiner 132 may determine the predetermined time threshold value TH on the basis of the number of object signs that are present in the predetermined range AR. In this case, the object sign density threshold value information 182 is information in which the number of object signs that are present in the predetermined range AR and the predetermined time threshold value TH are associated with each other.

[Regarding Distance Threshold Value Information 183]

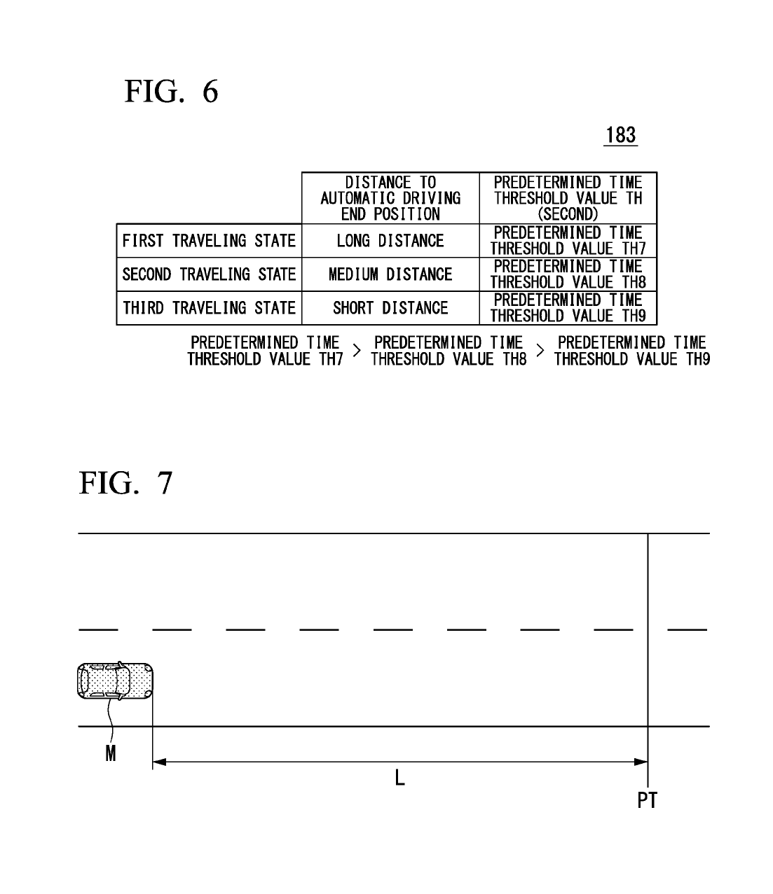

FIG. 6 is a diagram showing an example of content of the distance threshold value information 183. The distance threshold value information 183 is information in which the distance from the subject vehicle M to the automatic driving end position PT (hereinafter referred to as the distance to the automatic driving end position PT) and the predetermined time threshold value TH are associated with each other. Specifically, a “predetermined time threshold value TH7” is associated with a “long distance,” a “predetermined time threshold value TH8” is associated with a “medium distance,” and a “predetermined time threshold value TH9” is associated with a “short distance”. In the following description, a state in which the distance to the automatic driving end position PT is the “long distance” is also described as a “first traveling state,” a state in which the distance to the automatic driving end position PT is the “medium distance” is also described as a “second traveling state,” and a state in which the distance to the automatic driving end position PT is the “short distance” is also described as a “third traveling state”. A relationship among a length of time indicated by the predetermined time threshold value TH7, a length of time indicated by the predetermined time threshold value TH8, and a length of time indicated by the predetermined time threshold value TH9 is the predetermined time threshold value TH7>the predetermined time threshold value TH8>the predetermined time threshold value TH9.

FIG. 7 is a diagram schematically showing a determination process of the traveling state determiner 131 based on the distance to the automatic driving end position PT. For example, the traveling state determiner 131 determines the predetermined time threshold value TH on the basis of the distance (the shown distance L) to the automatic driving end position PT recognized by the recognizer 130.

In the following description, in a case in which the predetermined time threshold values TH1 to TH9 are not distinguished from each other, the predetermined time threshold values TH1 to TH9 are described as the predetermined time threshold value TH. In the present embodiment, a case in which all of the predetermined time threshold values TH (the predetermined time threshold value TH1, the predetermined time threshold value TH4, and the predetermined time threshold value TH7) associated with the first traveling state are values indicating the same length of time, all of the predetermined time threshold values TH (the predetermined time threshold value TH2, the predetermined time threshold value TH5, and the predetermined time threshold value TH8) associated with the second traveling state are values indicating the same length of time, and all of the predetermined time threshold values TH (the predetermined time threshold value TH3, the predetermined time threshold value TH6, and the predetermined time threshold value TH9) associated with the third traveling state are values indicating the same length of time will be described.

[Regarding Details of Determination of Specific Action Determiner 132]

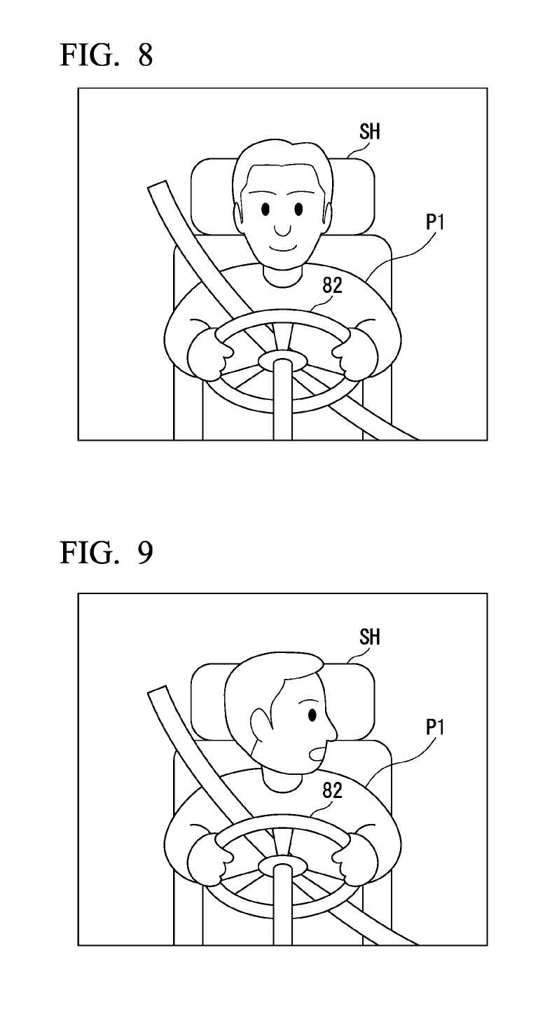

Hereinafter, the determination of the specific action determiner 132 will be described with reference to FIGS. 8 and 9. FIG. 8 is a diagram for explaining a process of the specific action determiner 132. In the example of FIG. 8, a driver P1 seated on a seat SH of a driver's seat of the subject vehicle M is shown. In the example of FIG. 8, a state in which the driver P1 grips a steering wheel (the shown steering wheel 82) that is an example of the driving operation element 80 and looks forward is shown. The specific action determiner 132 analyzes the image captured by the vehicle interior camera 300 and acquires an orientation of the face and a direction of a line of sight of the driver P1. For example, the specific action determiner 132 detects a positional relationship between a head portion and eyes of the driver P1, a combination of a reference point and a movement point in an eye, and the like from the image using a method such as template matching. In addition, the specific action determiner 132 derives an orientation of the face on the basis of the position of the eyes with respect to the head portion. The specific action determiner 132 derives the direction of the line of sight on the basis of the position of the movement point with respect to the reference point. For example, in a case in which the reference point is at an inner corner of the eye, the movement point is the iris. In a case in which the reference point is a corneal reflection region, the movement point is the pupil.

FIG. 9 is a diagram for explaining a process of the specific action determiner 132 in a case in which the orientation of the face of the driver changes. For example, the specific action determiner 132 compares a direction in which a visual recognition target of the subject vehicle M is present with the orientation of the face or the direction of the line of sight, and in a case in which the orientation of the face or the direction of the line of sight does not match or approximate the progress direction of the subject vehicle M, it is estimated that the driver P1 is distracted. In a case in which a distracted state of the driver P1 continues for a time equal to or longer than the predetermined time threshold value TH determined by the traveling state determiner 131, the specific action determiner 132 determines that the driver P1 is performing “distracted driving”. The “distracted driving” is an example of a “specific action”.

[Regarding Output Controller 133]

For example, in a case in which it is determined by the specific action determiner 132 that the driver is performing distracted driving, the output controller 133 causes the HMI 30 to output request information for requesting a specific operation.

The specific action is, for example, “an operation of returning the line of sight to the front (that is, an operation of ending the distraction)”. Specifically, the request information is, for example, information indicating a voice of a message such as “You are distracted from your driving, please return your line of sight to the front,” or information indicating an image that shows a message such as “Please look forward”. The output controller 133 causes the HMI 30 to output various kinds of information indicated in the request information on the basis of the request information. The request information may be information used when sounding a buzzer warning for distracted driving or information used when blinking a flash warning for distracted driving. The HMI 30 is an example of an “output”.

[Regarding Process Based on Vehicle Speed Threshold Value Information 181]

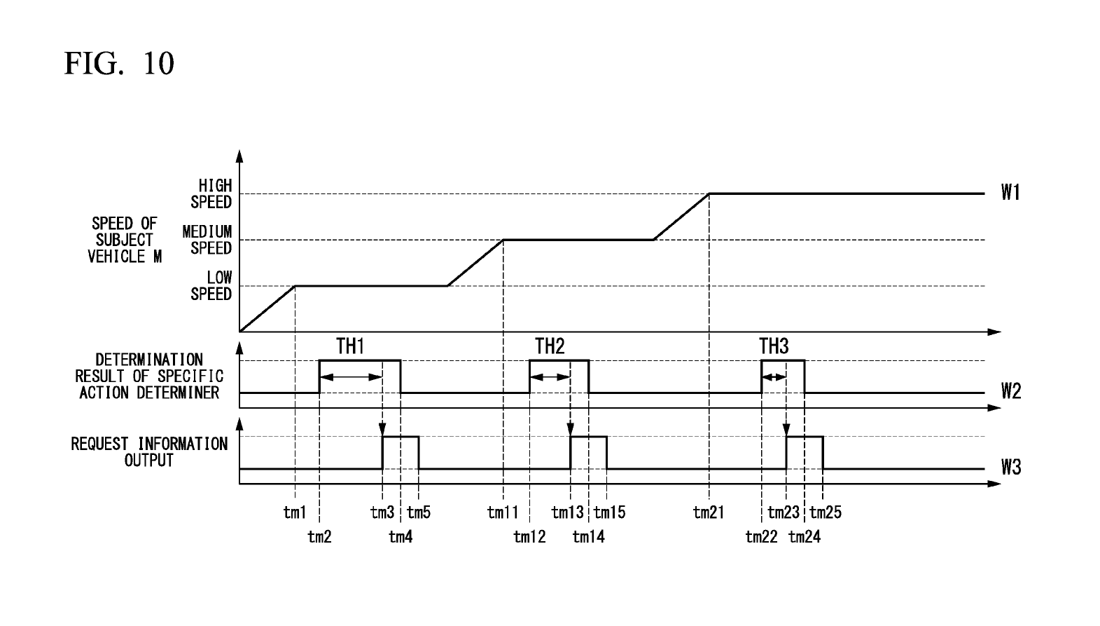

FIG. 10 is a diagram showing an example of processes of the traveling state determiner 131 and the specific action determiner 132 based on the speed of the subject vehicle M. In FIG. 10, a waveform W1 is a waveform showing a change in the speed of the subject vehicle M, a waveform W2 is a waveform showing the determination result of the specific action determiner 132, and a waveform W3 is a waveform showing a control state of the HMI 30 by the output controller 133. As shown by the waveform W1, the speed of the subject vehicle M reaches a “low speed” at a time tm1 from a start of traveling, and the “low speed” is maintained during a period from the time tm1 to a time tm11. Therefore, during the period from the time tm1 to the time tm11, the traveling state determiner 131 determines the predetermined time threshold value TH as the “predetermined time threshold value TH1” on the basis of the vehicle speed threshold value information 181.

The specific action determiner 132 detects that the driver is in the “distracted” state at a time tm2. Since the “distracted” state continues from the time tm2 to a time tm3 when the time indicated by the predetermined time threshold value TH1 has elapsed, the specific action determiner 132 determines that the driver is performing “distracted driving”. Since it is determined by the specific action determiner 132 that the driver is performing “distracted driving” at the time tm3, the output controller 133 causes the HMI 30 to output the request information from the time tm3 to a timing (a time tm4 shown in the figure) at which at least the “distracted” state of the driver is remedied. In a case in which the “distracted” state of the driver is remedied (a time tm5 shown in the figure), the output controller 133 causes the HMI 30 to stop the output.

As shown by the waveform W1, the speed of the subject vehicle M reaches a “medium speed” at the time tm11, and the “medium speed” is maintained during a period from the time tm11 to a time tm21. Therefore, during the period from the time tm11 to the time tm21, the traveling state determiner 131 determines the predetermined time threshold value TH as the “predetermined time threshold value TH2” on the basis of the vehicle speed threshold value information 181.

The specific action determiner 132 detects that the driver is in the “distracted” state at a time tm12. Since the “distracted” state continues from the time tm12 to a time tm13 when the time indicated by the predetermined time threshold value TH2 has elapsed, the specific action determiner 132 determines that the driver is performing the “distracted driving”. Since it is determined by the specific action determiner 132 that the driver is performing the “distracted driving” at the time tm13, the output controller 133 causes the HMI 30 to output the request information from the time tm13 to a timing (a time tm14 shown in the figure) at which at least the “distracted” state of the driver is remedied. In a case in which the “distracted” state of the driver is remedied (a time tm15 shown in the figure), the output controller 133 causes the HMI 30 to stop the output. Therefore, the output controller 133 is able to instantly request the “operation of returning the line of sight to the front” from the driver as compared with a case in which the speed of the subject vehicle M is the “low speed”.

As shown by the waveform W1, the speed of the subject vehicle M reaches a “high speed” at the time tm21, and the “high speed” is maintained after the time tm21. Therefore, after the time tm21, the traveling state determiner 131 determines the predetermined time threshold value TH as the “predetermined time threshold value TH3” on the basis of the vehicle speed threshold value information 181.

The specific action determiner 132 detects that the driver is in the “distracted” state at a time tm22. Since the “distracted” state continues from the time tm22 to a time tm23 when the time indicated by the predetermined time threshold value TH3 has elapsed, the specific action determiner 132 determines that the driver is performing the “distracted driving”. Since it is determined by the specific action determiner 132 that the driver is performing “distracted driving” at the time tm23, the output controller 133 causes the HMI 30 to output the request information from the time tm23 to a timing (a time tm24 shown in the figure) at which at least the “distracted” state of the driver is remedied. In a case in which the “distracted” state of the driver is remedied (a time tm25 shown in the figure), the output controller 133 causes the HMI 30 to stop the output. Therefore, the output controller 133 is able to instantly request the “operation of returning the line of sight to the front” from the driver as compared with a case in which the speed of the subject vehicle M is “low speed” or “medium speed”.

[Regarding Process Based on Object Sign Density Threshold Value Information 182]

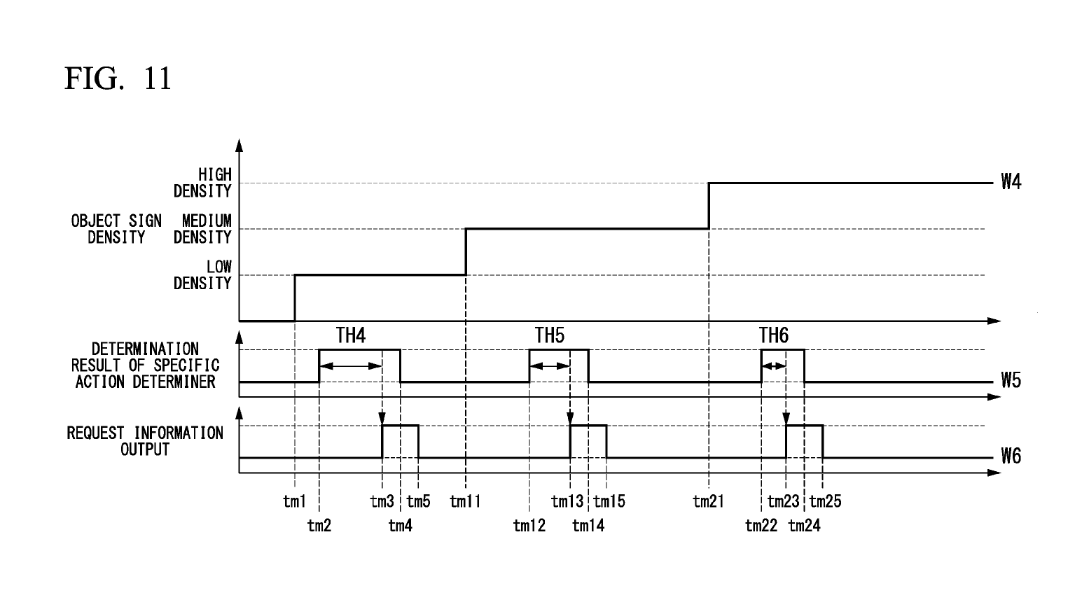

FIG. 11 is a diagram showing an example of the processes of the traveling state determiner 131 and the specific action determiner 132 based on the object sign density. In FIG. 11, a waveform W4 is a waveform showing a change in the object sign density, a waveform W5 is a waveform showing the determination result of the specific action determiner 132, and the waveform W5 is a waveform showing the control state of the HMI 30 by the output controller 133. As shown by the waveform W4, the object sign density of the subject vehicle M is “low density” at the time tm1 from the start of the traveling, and a “low density” state is maintained during the period from the time tm1 to the time tm11. Therefore, during the period from the time tm1 to the time tm11, the traveling state determiner 131 determines the predetermined time threshold value TH as the “predetermined time threshold value TH4” on the basis of the object sign density threshold value information 182.

The specific action determiner 132 detects that the driver is in the “distracted” state at the time tm2. Since the “distracted” state continues from the time tm2 to the time tm3 when the time indicated by the predetermined time threshold value TH4 has elapsed, the specific action determiner 132 determines that the driver is performing “distracted driving”. Since it is determined by the specific action determiner 132 that the driver is performing “distracted driving” at the time tm3, the output controller 133 causes the HMI 30 to output the request information from the time tm3 to the timing (the time tm4 shown in the figure) at which at least the “distracted” state of the driver is remedied. In a case in which the “distracted” state of the driver is remedied (the time tm5 shown in the figure), the output controller 133 causes the HMI 30 to stop the output.

As shown by the waveform W4, the object sign density of the subject vehicle M reaches a “medium density” at the time tm11, and the “medium density” state is maintained during the period from the time tm11 to the time tm21. Therefore, during the period from the time tm11 to the time tm21, the traveling state determiner 131 determines the predetermined time threshold value TH as the “predetermined time threshold value TH5” on the basis of the object sign density threshold value information 182.

The specific action determiner 132 detects that the driver is in the “distracted” state at the time tm12. Since the “distracted” state continues from the time tm12 to the time tm13 when the time indicated by the predetermined time threshold value TH5 has elapsed, the specific action determiner 132 determines that the driver is performing the “distracted driving”. Since it is determined by the specific action determiner 132 that the driver is performing “distracted driving” at the time tm13, the output controller 133 causes the HMI 30 to output the request information from the time tm13 to the timing (the time tm14 shown in the figure) at which at least the “distracted” state of the driver is remedied. In a case in which the “distracted” state of the driver is remedied (the time tm15 shown in the figure), the output controller 133 causes the HMI 30 to stop the output. Therefore, the output controller 133 is able to instantly request the “operation of returning the line of sight to the front” from the driver as compared with a case in which the object sign density of the subject vehicle M is the “low density”.

As shown by the waveform W4, the object sign density of the subject vehicle M reaches a “high density” at the time tm21, and a state of the “high density” is maintained after the time tm21. Therefore, after the time tm21, the traveling state determiner 131 determines the predetermined time threshold value TH as the “predetermined time threshold value TH6” on the basis of the object sign density threshold value information 182.

The specific action determiner 132 detects that the driver is in the “distracted” state at the time tm22. Since the “distracted” state continues from the time tm22 to the time tm23 when the time indicated by the predetermined time threshold value TH6 has elapsed, the specific action determiner 132 determines that the driver is performing the “distracted driving”. Since it is determined by the specific action determiner 132 that the driver is performing the “distracted driving” at the time tm23, the output controller 133 causes the HMI 30 to output the request information from the time tm23 to the timing (the time tm24 shown in the figure) at which at least the “distracted” state of the driver is remedied. In a case in which the “distracted” state of the driver is remedied (the time tm25 shown in the figure), the output controller 133 causes the HMI 30 to stop the output. Therefore, the output controller 133 is able to instantly request the “operation of returning the line of sight to the front” from the driver as compared with a case in which the object sign density of the subject vehicle M is “low density” or “medium density”.

[Regarding Process Based on Distance Threshold Value Information 183]

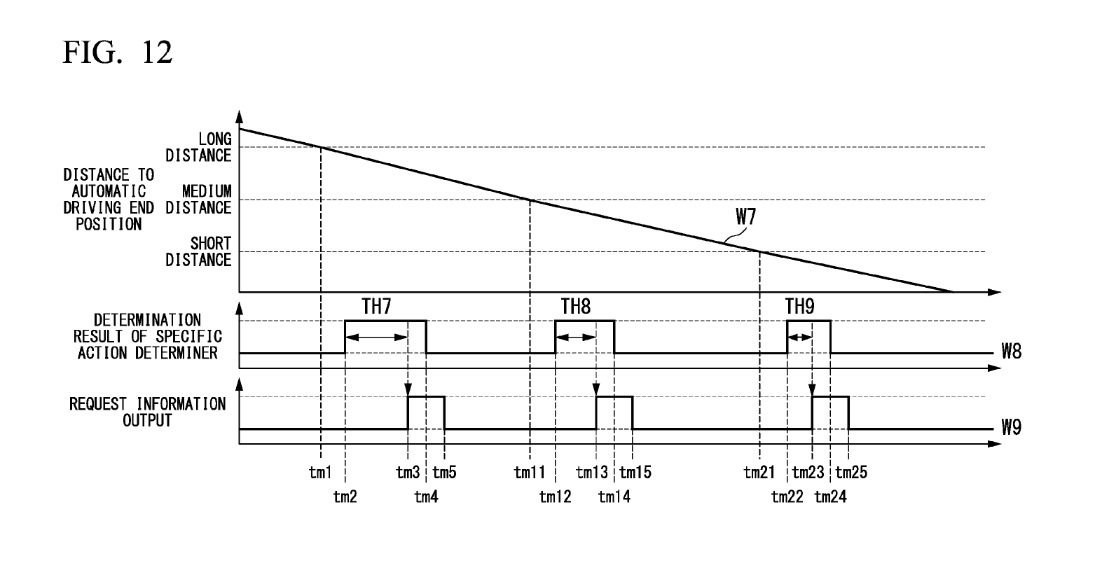

FIG. 12 is a diagram showing an example of the processes of the traveling state determiner 131 and the specific action determiner 132 based on the distance to the automatic driving end position PT. In FIG. 12, a waveform W7 is a waveform showing the change in the distance to the automatic driving end position PT, a waveform W8 is a waveform showing the determination result of the specific action determiner 132, and a waveform W9 is a waveform showing the control state of the HMI 30 by the output controller 133. As shown by the waveform W7, the distance to the automatic driving end position PT is a “long distance” at the time tm1 and is the “long distance” during the period from the time tm1 to the time tm11. Therefore, during the period from the time tm1 to the time tm11, the traveling state determiner 131 determines the predetermined time threshold value TH as the “predetermined time threshold value TH7” on the basis of the distance threshold value information 183.

The specific action determiner 132 detects that the driver is in the “distracted” state at the time tm2. Since the “distracted” state continues from the time tm2 to the time tm3 when the time indicated by the predetermined time threshold value TH7 has elapsed, the specific action determiner 132 determines that the driver is performing “distracted driving”. Since it is determined by the specific action determiner 132 that the driver is performing the “distracted driving” at the time tm3, the output controller 133 causes the HMI 30 to output the request information from the time tm3 to the timing (the time tm4 shown in the figure) at which at least the “distracted” state of the driver is remedied. In a case in which the “distracted” state of the driver is remedied (the time tm5 shown in the figure), the output controller 133 causes the HMI 30 to stop the output.

As shown by the waveform W7, the subject vehicle M reaches a position at which the distance to the automatic driving end position PT is a “medium distance” at the time tm11 and travels to the position of the “medium distance” during a time from the time tm11 to the time tm21. Therefore, during the period from the time tm11 to the time tm21, the traveling state determiner 131 determines the predetermined time threshold value TH as the “predetermined time threshold value TH8” on the basis of the distance threshold value information 183.

The specific action determiner 132 detects that the driver is in the “distracted” state at the time tm12. Since the “distracted” state continues from the time tm12 to the time tm13 when the time indicated by the predetermined time threshold value TH8 has elapsed, the specific action determiner 132 determines that the driver is performing the “distracted driving”. Since it is determined by the specific action determiner 132 that the driver is performing the “distracted driving” at the time tm13, the output controller 133 causes the HMI 30 to output the request information from the time tm13 to the timing (the time tm14 shown in the figure) at which at least the “distracted” state of the driver is remedied. In a case in which the “distracted” state of the driver is remedied (the time tm15 shown in the figure), the output controller 133 causes the HMI 30 to stop the output. Therefore, the output controller 133 is able to instantly request the “operation of returning the line of sight to the front” from the driver as compared with a case in which the distance to the automatic driving end position PT is the “long distance”.

As shown by the waveform W7, the subject vehicle M reaches a position at which the distance to the automatic driving end position PT is a “short distance” at the time tm21 and travels to the position of the “short distance” after the time tm21. Therefore, after the time tm21, the traveling state determiner 131 determines the predetermined time threshold value TH as the “predetermined time threshold value TH9” on the basis of the distance threshold value information 183.

The specific action determiner 132 detects that the driver is in the “distracted” state at the time tm22. Since the “distracted” state continues from the time tm22 to the time tm23 when the time indicated by the predetermined time threshold value TH9 has elapsed, the specific action determiner 132 determines that the driver is performing the “distracted driving”. Since it is determined by the specific action determiner 132 that the driver is performing the “distracted driving” at the time tm23, the output controller 133 causes the HMI 30 to output the request information from the time tm23 to the timing (the time tm24 shown in the figure) at which at least the “distracted” state of the driver is remedied. In a case in which the “distracted” state of the driver is remedied (the time tm25 shown in the figure), the output controller 133 causes the HMI 30 to stop the output. Therefore, the output controller 133 is able to instantly request the “operation of returning the line of sight to the front” from the driver as compared with a case in which the distance to the automatic driving end position PT is “long distance” or “medium distance”.

[Regarding Specific Action Other Than Distraction]

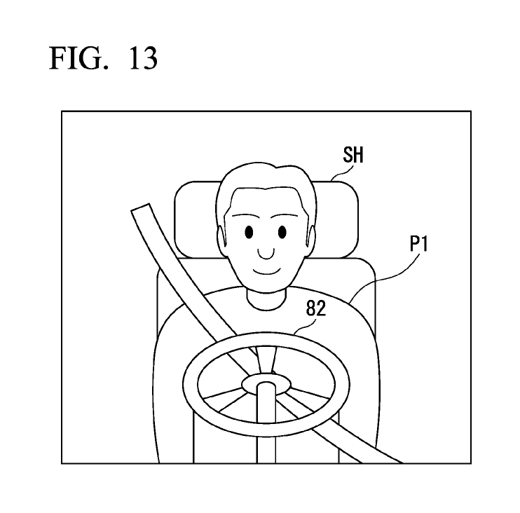

In the above description, a case in which the specific action of the driver determined by the specific action determiner 132 is “distraction” has been described, but the present invention is not limited thereto. The specific action determiner 132 may change the specific action of to be noticed according to a degree of the automatic driving control of the automatic driving control device 100. Specifically, in a case in which the operation mode of the automatic driving by the automatic driving control device 100 is the lane keeping control in a state in which the steering wheel is gripped, the action required of the driver is an action of gripping the steering wheel. In a case in which the operation mode of the automatic driving by the automatic driving control device 100 is the lane keeping control in the state in which the steering wheel is gripped, the specific action is, for example, an action of letting go of the steering wheel 82 (hereinafter, hands-free). FIG. 13 is a diagram for explaining the process of the specific action determiner 132 in a case in which the driver P1 releases his or her hands. For example, the specific action determiner 132 analyzes the image captured by the vehicle interior camera 300 and acquires positions of the hands of the driver P1. For example, the specific action determiner 132 detects a positional relationship of the hands of the driver P1 from the image using a method such as template matching. For example, in a case in which the positions of the hands of the driver P1 do not match or approximate a position of the steering wheel 82, the specific action determiner 132 estimates that the driver P1 is in a hands-free state. In a case in which the driver P1 continues the hands-free state for a time equal to or longer than the predetermined time threshold value TH determined by the traveling state determiner 131, the specific action determiner 132 determines that the driver P1 is performing “hands-free driving”. The “hands-free driving” is an example of the “specific action”.

In this case, the output controller 133 causes the HMI 30 to output the request information for requesting an “operation of gripping the steering wheel 82”. The “operation of gripping the steering wheel 82” is an example of the “specific operation”.

The traveling state determiner 131 may have a constitution for determining whether the driver P1 is in the hands-free state on the basis of a detection result of a grip sensor provided in the steering wheel 82 instead of a constitution for analyzing the image captured by the vehicle interior camera 300 and determining whether the driver P1 is in the hands-free state.

[Process Flow of Traveling State Determiner 131]

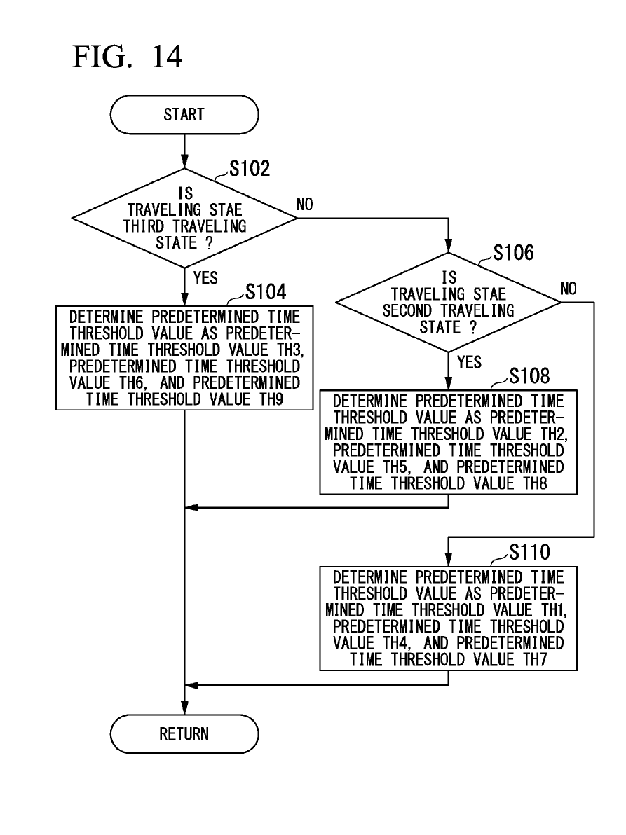

FIG. 14 is a flowchart showing an example of the determination process of the traveling state determiner 131. The process of the flowchart shown in FIG. 14 is executed at predetermined time intervals. The traveling state determiner 131 determines whether or not the traveling state of the subject vehicle M is the “third traveling state” (that is, the speed of the subject vehicle M is the “high speed,” the object sign density is “high density,” or the distance to the automatic driving end position PT is “short distance”) (step S102). Here, in a case in which at least one of “high speed,” “high density,” or “short distance” matches, the traveling state determiner 131 determines that the traveling state of the subject vehicle M is the “third traveling state”. Next, in a case in which the traveling state of the subject vehicle M is the “third traveling state,” the traveling state determiner 131 determines the predetermined time threshold value TH as the predetermined time threshold value TH (for example, the predetermined time threshold value TH3, the predetermined time threshold value TH6, and the predetermined time threshold value TH9) corresponding to the “third traveling state” (step S104).

Next, in a case in which the traveling state of the subject vehicle M is not the “third traveling state,” the traveling state determiner 131 determines whether or not the traveling state of the subject vehicle M is the “second traveling state” (that is, the speed of the subject vehicle M is “medium speed,” the object sign density is “medium density,” or the distance to the automatic driving end position PT is “medium distance”) (step S106). Here, in a case in which at least one of “medium speed,” “medium density,” or “medium distance” matches, the traveling state determiner 131 determines that the traveling state of the subject vehicle M is the “second traveling state”. Next, in a case in which the traveling state of the subject vehicle M is the “second traveling state,” the traveling state determiner 131 determines the predetermined time threshold value TH as the predetermined time threshold value TH (for example, the predetermined time threshold value TH2, the predetermined time threshold value TH5, and the predetermined time threshold value TH8) corresponding to the “second traveling state” (step S108). Next, in a case in which the traveling state of the subject vehicle M is not the “second traveling state,” the traveling state determiner 131 determines that the traveling state of the subject vehicle M is the “first traveling state” and determines the predetermined time threshold value TH as the predetermined time threshold value TH1, the predetermined time threshold value TH4, and the predetermined time threshold value TH7 (step S110).

In the above description, a case in which the traveling state determiner 131 determines the predetermined time threshold value TH on the basis of all of the speed of the subject vehicle M, the object sign density, and the distance to the automatic driving end position PT has been described, however, the present invention is not limited thereto. The traveling state determiner 131 may be constituted to determine the predetermined time threshold value TH on the basis of at least one of the speed of the subject vehicle M, the object sign density, and the distance to the automatic driving end position PT. In this case, the predetermined time threshold value TH (the predetermined time threshold value TH1, the predetermined time threshold value TH4, and the predetermined time threshold value TH7) associated with the first traveling state may be values indicating different time lengths, the predetermined time threshold value TH (the predetermined time threshold value TH2, the predetermined time threshold value TH5, and the predetermined time threshold value TH8) associated with the second traveling state may be values indicating different time lengths, and the predetermined time threshold value TH (the predetermined time threshold value TH3, the predetermined time threshold value TH6, and the predetermined time threshold value TH9) associated with the third traveling state may be values indicating different time lengths.

[Process Flow of Specific Action Determiner 132]

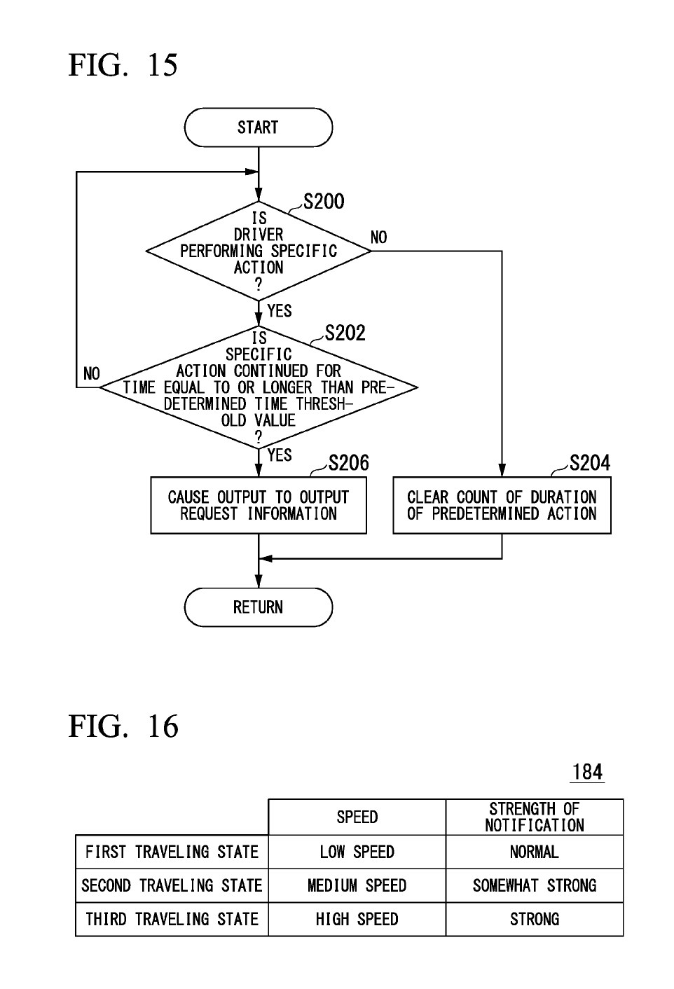

FIG. 15 is a flowchart showing an example of the determination process of the specific action determiner 132. The process of the flowchart shown in FIG. 15 is executed at predetermined time intervals. The specific action determiner 132 determines whether or not the driver is performing the specific action (for example, distracted or hands-free) on the basis of the image captured by the vehicle interior camera 300 (step S200). In a case in which the driver is not performing the specific action, the specific action determiner 132 clears a counter that counts a duration of the specific action (step S204), and ends the process.

Next, in a case in which it is determined that the driver is performing a specific action, the specific action determiner 132 determines whether or not the duration of the specific action is equal to or longer than the predetermined time threshold value TH (step S202). In a case in which the duration of the specific action is not equal to or longer than the predetermined time threshold value TH, the specific action determiner 132 advances the process to step S200. In a case in which it is determined by the specific action determiner 132 that the duration of the specific action is equal to or longer than the predetermined time threshold value TH, the output controller 133 causes the HMI 30 to output the request information (step S206).

[Regarding Determination of Predetermined Time Threshold Value TH Based on Curvature of Road on Which Subject Vehicle M Travels]

The traveling state determiner 131 may be configured to determine the curvature of the road on which the subject vehicle M travels as the ambient environment of the subject vehicle M and determine the predetermined time threshold value TH. Specifically, in a case in which the road on which the subject vehicle M travels is curved, the traveling state determiner 131 decreases a threshold value of the speed when determining “low speed”, “medium speed”, or “high speed” as a whole. In a case in which the road on which the subject vehicle M travels is curved, the traveling state determiner 131 decreases a threshold value of the object sign density when determining “low density”, “medium density”, or “high density” as a whole. Therefore, in a case in which the road on which the subject vehicle M travels is curved, the traveling state determiner 131 is able to apply bias so as to determine the predetermined time threshold value TH with more stringent conditions.

[Regarding Determination of Predetermined Time Threshold Value TH Based on Recognition Result of Recognizer 130]

The traveling state determiner 131 may be constituted to determine the predetermined time threshold value TH on the basis of the accuracy of the recognition result of the recognizer 130. Specifically, in a case in which the accuracy of the recognition of the a traveling road boundary (a road boundary) including a road lane marking, a road shoulder, a curb, a median strip, a guard rail, and the like, a stop line, an obstacle, or the like, that is recognized by the recognizer 130 is low, the traveling state determiner 131 decreases the threshold value of the speed when determining “low speed”, “medium speed”, or “high speed” as a whole. A case in which the accuracy of the recognition of the recognizer 130 is low includes a case in which time taken to acquire the recognition result is longer than a predetermined time (for example, in a case of rain), or the like. In a case in which the accuracy of the recognition of the recognizer 130 is low, the traveling state determiner 131 decreases the threshold value of the object sign density when determining “low density”, “medium density”, or “high density”, in a case in which the road on which the subject vehicle M travels is curved. Therefore, in a case in which the accuracy of the recognition by the recognizer 130 is low, the traveling state determiner 131 is able to apply bias so as to determine the predetermined time threshold value TH with more stringent conditions.

[Summary of Embodiment]

As described above, the automatic driving control device 100 according to the present embodiment includes the recognizer 130 that recognizes the surrounding situation of the subject vehicle M, the driving controller (in this example, the action plan generator 140 and the second controller 160) that controls the at least one of steering and acceleration/deceleration of the subject vehicle M on the basis of the recognition result of the recognizer 130, the specific action determiner 132 that determines whether or not the specific action (in this example, the “distraction” and “hands-free”) by the driver of the driver continues for the predetermined time or more in a state in which the driving controller is operated, the HMI 30 that outputs the information, and the output controller 133 that causes the HMI 30 to output the request information for requesting the specific operation (in this example, the “operation of returning the line of sight to the front” or the “operation of gripping the steering wheel 82” from the driver in a case in which it is determined by the specific action determiner 132 that the specific action continues for the predetermined time (in this example, the predetermined time threshold value TH) or more. The traveling state determiner 131 is able to change the predetermined time threshold value TH according to the traveling state of the subject vehicle M and is able to more suitably determine the distracted driving or the hands-free driving.

### MODIFIED EXAMPLE

Hereinafter, a modified example of the embodiment will be described. In the embodiment, a case in which it is determined whether or not the driver is performing the specific action according to the traveling state of the subject vehicle M and the condition (the predetermined time threshold value TH) for the elapsed time is changed has been described. In the modified example, a case in which the request information is changed according the number of times the driver has been notified of the request information will be described. Constitutions similar to those of the above-described embodiment are denoted by the same reference numerals, and description thereof will be omitted.

FIG. 16 is a diagram showing an example of content of the notification strength information 184. As shown in FIG. 16, the notification strength information 184 is information in which the speed of the vehicle M and a strength of a notification of the request information are associated with each other. Specifically, “low speed” is associated with “normal” as the strength of the notification, “medium speed” is associated with “somewhat strong” as the strength of the notification, and “high speed” is associated with “strong” as the strength of the notification. The notification strength information 184 is stored, for example, in the storage 180. The content in which the strength of the notification is “somewhat strong” is changing a size or display of a character of a message shown in the image so as to be more easily recognized by the driver as compared with a case in which the strength of the notification is “normal”, or greatly changing a volume of the notification. The content in which the strength of the notification is “strong” is changing the image or the volume so as to be more easily recognized by the driver as compared with a case in which the strength of the notification is “somewhat strong”.

For example, the request information according to the strength of each notification is stored in the storage 180, and the output controller 133 causes the HMI 30 to output the request information associated with each traveling state on the basis of the determination result of the traveling state determiner 131. The strength of the notification of the request information may be associated with the object sign density or may be associated with the distance to the automatic driving end position PT.

[Regarding Process Based on Notification Strength Information 184]

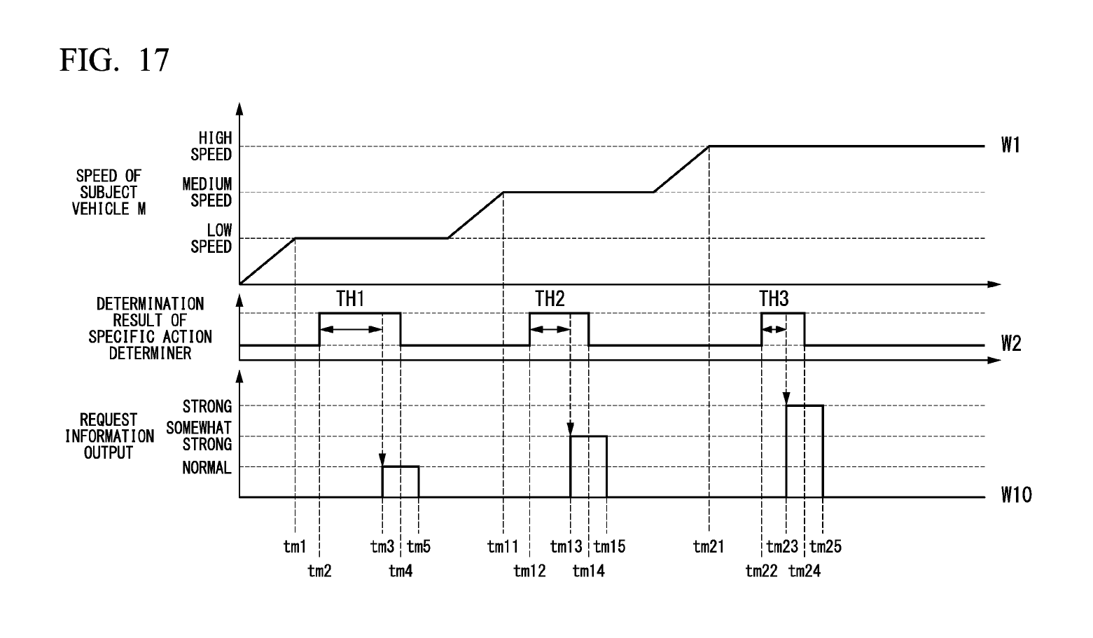

FIG. 17 is a diagram showing an example of a process of the output controller 133. In FIG. 17, a waveform W1 is a waveform similar to the waveform W1 shown in FIG. 10, a waveform W2 is a waveform similar to the waveform W2 shown in FIG. 10, and a waveform W10 is a waveform showing a control state of the HMI 30 by the traveling state determiner 131 of the modified example. As shown by the waveform W1, the speed of the subject vehicle M reaches “low speed” at the time tm1 since the start of the traveling, and “low speed” is maintained during the period from the time tm1 to the time tm11. Therefore, during the period from the time tm1 to the time tm11, the output controller 133 determines the strength of the notification of the request information to be “normal” on the basis of the notification strength information 184.

The specific action determiner 132 detects that the driver is in the “distraction” state at the time tm2. Since the “distraction” state continues from the time tm2 to the time tm3 when the time indicated by the predetermined time threshold value TH1 has elapsed, the specific action determiner 132 determines that the driver is performing the “distracted driving”. Since it is determined by the specific action determiner 132 that the driver is performing the “distracted driving” at the time tm3, the output controller 133 causes the HMI 30 to output the request information with the “normal” strength of the notification from the time tm3 to the timing (the time tm4 shown in the figure) at which at least the “distraction” state of the driver is remedied. In a case in which the “distraction” state of the driver is remedied (the time tm5 shown in the figure), the output controller 133 causes the HMI 30 to stop the output.

As shown by the waveform W1, the speed of the subject vehicle M reaches “medium speed” at the time tm11, and “medium speed” is maintained during the period from the time tm11 to the time tm21. Therefore, during the period from the time tm11 to the time tm21, the output controller 133 determines the strength of the notification of the request information to be “somewhat strong” on the basis of the notification strength information 184.

The specific action determiner 132 detects that the driver is in the “distraction” state at the time tm12. Since the “distraction” state continues from the time tm12 to the time tm13 when the time indicated by the predetermined time threshold value TH2 has elapsed, the specific action determiner 132 determines that the driver is performing “distracted driving”. Since it is determined by the specific action determiner 132 that the driver is performing “distracted driving” at the time tm13, the output controller 133 causes the HMI 30 to output the request information with a “somewhat strong” strength of the notification from the time tm13 to the timing (the time tm14 shown in the figure) at which at least the “distraction” state of the driver is remedied. In a case in which the “distraction” state of the driver is remedied (the time tm15 shown in the figure), the output controller 133 causes the HMI 30 to stop the output. Therefore, the output controller 133 is able to somewhat strongly request the driver the “operation of returning the line of sight to the front” as compared with a case in which the speed of the subject vehicle M is “low speed”

As shown by the waveform W1, the speed of the subject vehicle M reaches “high speed” at the time tm21, and “high speed” is maintained after the time tm21. Therefore, after the time tm21, the output controller 133 determines the strength of the notification of the request information to be “strong” on the basis of the notification strength information 184.

The specific action determiner 132 detects that the driver is in the “distraction” state at the time tm22. Since the “distraction” state continues from the time tm22 to the time tm23 when the time indicated by the predetermined time threshold value TH3 has elapsed, the specific action determiner 132 determines that the driver is performing the “distracted driving”. Since it is determined by the specific action determiner 132 that the driver is performing “distracted driving” at the time tm23, the output controller 133 causes the HMI 30 to output the request information with a “strong” strength of the notification from the time tm23 to the timing (the time tm24 shown in the figure) at which at least the “distraction” state of the driver is remedied. In a case in which the “distraction” state of the driver is remedied (the time tm25 shown in the figure), the output controller 133 causes the HMI 30 to stop the output. Therefore, the output controller 133 is able to strongly request the driver the “operation of returning the line of sight to the front” as compared with a case in which the speed of the subject vehicle M is “low speed” and “medium speed”.

[Regarding Change of Notification Aspect Based on Number of Times of Outputs of Request Information]

In the above description, a case in which the output controller 133 changes the strength of the notification of the request information on the basis of the traveling state of the subject vehicle M, but the present invention is not limited thereto. For example, the output controller 133 may be constituted to change the strength of the notification of the request information on the basis of the number of times the driver has been notified of the request information in one driving period.

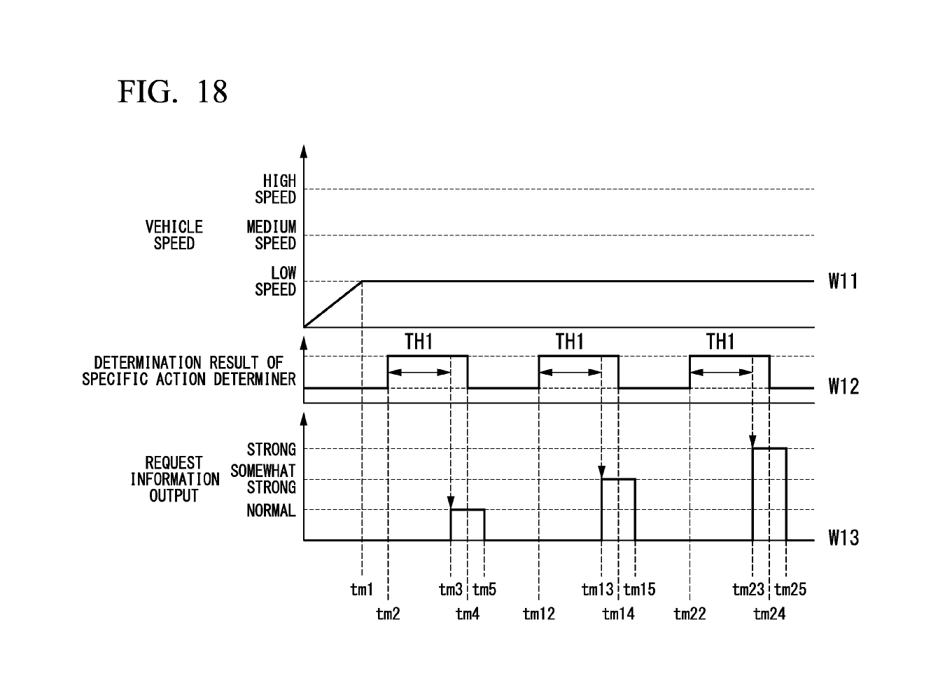

FIG. 18 is a diagram showing another example of the process of the output controller 133. In FIG. 18, a waveform W11 is a waveform showing a change in the speed of the subject vehicle M, a waveform W12 is a waveform showing the determination result of the specific action determiner 132, and a waveform W13 is a waveform showing the control state of the HMI 30 by the output controller 133. As shown by the waveform W11, the speed of the subject vehicle M reaches “low speed” at the time tm1 since the start of the traveling, and “low speed” is maintained after the time tm1.

The specific action determiner 132 detects that the driver is in the “distraction” state at the time tm2. Since the “distraction” state continues from the time tm2 to the time tm3 when the time indicated by the predetermined time threshold value TH1 has elapsed, the specific action determiner 132 determines that the driver is performing first “distracted driving”. Since it is determined by the specific action determiner 132 that the driver is performing the “distracted driving” at the time tm3, the output controller 133 causes the HMI 30 to output the request information with “normal” strength of the notification from the time tm3 to the timing (the time tm4 shown in the figure) at which at least the “distraction” state of the driver is remedied. In a case in which the “distraction” state of the driver is remedied (the time tm5 shown in the figure), the output controller 133 causes the HMI 30 to stop the output.

The specific action determiner 132 detects that the driver is in the “distraction” state at the time tm12. Since the “distraction” state continues from the time tm12 to the time tm13 when the time indicated by the predetermined time threshold value TH1 has elapsed, the specific action determiner 132 determines that the driver is performing second “distracted driving”. Since it is determined by the specific action determiner 132 that the driver is performing the “distracted driving” at the time tm13, the output controller 133 causes the HMI 30 to output the request information of which the output aspect is changed to the “somewhat strong” strength of the notification as compared with the first (“normal” strength) notification from the time tm13 to the timing (the time tm14 shown in the figure) at which at least the “distraction” state of the driver is remedied. In a case in which the “distraction” state of the driver is remedied (the time tm15 shown in the figure), the output controller 133 causes the HMI 30 to stop the output. Therefore, the output controller 133 is able to strongly request the driver the “operation of returning the line of sight to the front” as compared with the first “distracted driving”.

The specific action determiner 132 detects that the driver is in the “distraction” state at the time tm22. Since the “distraction” state continues from the time tm22 to the time tm23 when the time indicated by the predetermined time threshold value TH1 has elapsed, the specific action determiner 132 determines that the driver is performing third “distracted driving”. Since it is determined by the specific action determiner 132 that the driver is performing the “distracted driving” at the time tm23, the output controller 133 causes the HMI 30 to output the request information of which the output aspect is changed to the “strong” notification as compared with the second (“somewhat strong” strength) notification from the time tm23 to the timing (the time tm24 shown in the figure) at which at least the “distraction” state of the driver is remedied. In a case in which the “distraction” state of the driver is remedied (the time tm25 shown in the figure), the output controller 133 causes the HMI 30 to stop the output. Therefore, the output controller 133 is able to strongly request the driver the “operation of returning the line of sight to the front” as compared with the first and second “distracted driving”.

[Hardware Constitution]

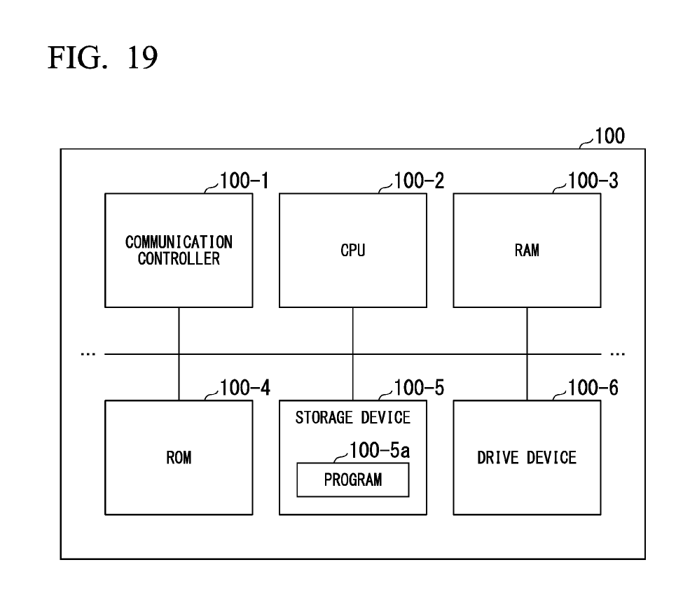

FIG. 19 is a diagram showing an example of a hardware constitution of the automatic driving control device 100 according to an embodiment. As shown in the figure, the automatic driving control device 100 includes a constitution in which a communication controller 100-1, a CPU 100-2, a RAM 100-3 used as a working memory, a ROM 100-4 storing a boot program and the like, a storage device 100-5 such as a flash memory or an HDD, a drive device 100-6 and the like are mutually connected by an internal bus or a dedicated communication line. The communication controller 100-1 communicates with components other than the automatic driving control device 100. A program 100-5a executed by the CPU 100-2 is stored in the storage device 100-5. This program is developed in the RAM 100-3 by a direct memory access (DMA) controller (not shown) or the like and executed by the CPU 100-2. Therefore, a part or all of the first controller 120 and the second controller 160 are realized.

The above-described embodiment is able to be expressed as follows.

A vehicle control device constituted to include:

a storage that stores a program;

a storage device that stores information; and

a hardware processor that executes the program stored in the storage device,

wherein the hardware processor executes the program to:

recognize a surrounding situation of a subject vehicle;

control at least one of steering and acceleration/deceleration of the subject vehicle on the basis of a recognition result;

determine whether or not a driver of the subject vehicle performs a specific action in a state in which the control of the at least one of steering and acceleration/deceleration of the subject vehicle is operated;

output request information for requesting a specific operation from the driver in a case in which it is determined that the driver performs the specific action;

determine whether or not the driver performs the specific action according to an elapsed time of the specific action; and

change a condition for the elapsed time according to a traveling state of the subject vehicle.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer that recognizes a surrounding situation of a subject vehicle;
a driving controller that controls at least one of steering and acceleration/deceleration of the subject vehicle on the basis of a recognition result of the recognizer;
a continuation determiner that determines whether or not a specific action by a driver of the subject vehicle other than an action required of the driver continues for a predetermined time or more so that the driving controller operates in a state in which the driving controller is operated;
an output that outputs information; and
an output controller that causes the output to output request information for requesting a specific operation from the driver in a case in which it is determined by the continuation determiner that the specific action continues for the predetermined time or more,
wherein the continuation determiner changes the predetermined time according to a traveling state of the subject vehicle or an ambient environment of the subject vehicle.

2. A vehicle control device comprising:
a recognizer that recognizes a surrounding situation of a subject vehicle;
a driving controller that controls at least one of steering and acceleration/deceleration of the subject vehicle based on a recognition result of the recognizer;
a continuation determiner that determines whether or not a specific action by a driver of the subject vehicle other than an action required of the driver continues for a predetermined time or more so that the driving controller operates in a state in which the driving controller is operated;
an output that outputs information; and
an output controller that causes the output to output request information for requesting a specific operation from the driver in a case in which it is determined by the continuation determiner that the specific action continues for the predetermined time or more,
wherein the output controller changes an output aspect of the request information according to a traveling state of the subject vehicle or an ambient environment of the subject vehicle.

3. The vehicle control device of claim 1,
wherein, after the output controller causes the output to output the request information at least once or more, in a case in which it is determined by the continuation determiner that the specific action continues for the predetermined time or more, the output controller sets an output aspect of the request information to be stronger than a first output aspect.

4. The vehicle control device of claim 1,
wherein the continuation determiner changes the specific action to be noticed according to a control degree with which the driving controller performs control.

5. The vehicle control device of claim 1,
wherein the traveling state is a state based on a speed of the subject vehicle or a distance to a position at which an operation of the driving controller is changed.

6. The vehicle control device of claim 1,
wherein the ambient environment is at least one of an object sign density around the subject vehicle, a curvature of a route along which the subject vehicle travels, or accuracy of the recognition result by the recognizer.

7. A vehicle control method of causing a computer to:
recognize a surrounding situation of a subject vehicle;
control at least one of steering and acceleration/deceleration of the subject vehicle on the basis of a recognition result;
determine whether or not a specific action by a driver of the subject vehicle other than an action required of the driver continues for a predetermined time or more so that the control is operated in a state in which the control of the at least one of steering and acceleration/deceleration of the subject vehicle is operated;
output request information for requesting a specific operation from the driver in a case in which it is determined that the specific action continues for the predetermined time or more; and
change the predetermined time according to a traveling state of the subject vehicle or an ambient environment of the subject vehicle.

8. A storage medium that causes a computer to:
recognize a surrounding situation of a subject vehicle;
control at least one of steering and acceleration/deceleration of the subject vehicle on the basis of a recognition result;
determine whether or not a specific action by a driver of the subject vehicle other than an action required of the driver continues for a predetermined time or more so that the control is operated in a state in which the control of the at least one of steering and acceleration/deceleration of the subject vehicle is operated;
output request information for requesting a specific operation from the driver in a case in which it is determined that the specific action continues for the predetermined time or more; and
change the predetermined time according to a traveling state of the subject vehicle or an ambient environment of the subject vehicle.
